(19) United States
(12) Patent Application Publication
(10) Pub. No.: US 2015/0108942 A1
(43) Pub. Date: Apr. 23, 2015

(54) CHARGEABLE DEVICE

(71) Applicant: AIROHA TECHNOLOGY CORP., HSINCHU (TW)

(72) Inventors: HENG-CHIH LIN, HSINCHU (TW); YU-HUA LIU, HSINCHU (TW)

(21) Appl. No.: 14/279,490

(22) Filed: May 16, 2014

(30) Foreign Application Priority Data
Oct. 21, 2013 (CN) 201310495173.0

(51) Int. Cl. H02J 7/02; H02J 7/00; H04R 1/00

(52) U.S. Cl. CPC H02J 7/025; H04R 1/00; H02J 7/0042
USPC 320/108

(57) ABSTRACT

A chargeable device is disclosed. The chargeable device of the present invention comprises a main circuit module with a coil, and at least one integrated circuit module with a compensation capacitor operated with the coil.

### FIELD OF THE INVENTION

The present invention relates to a chargeable device, and particularly to a wireless chargeable device.

### BACKGROUND OF THE INVENTION

For the convenience of the users, more and more functions are integrated to one device. For example, a mobile phone is integrated with functions of wireless network communication, multimedia display, radio frequency identification (RFID), near field communication (NFC), and etc. Moreover, for the product design integrity, waterproofness, and the convenience for charging, more and more devices are designed with function of wireless charging.

In general, for mobile communication system, wireless network communication system, RFID system, NFC system, and wireless charging system, each system comprises individual antenna or coil for receiving and transmitting signal. It is difficult to integrate so many systems in a small device. Furthermore, to prevent each system from electromagnetic interference is also a big problem for the designers and engineers.

### SUMMARY OF THE PRESENT INVENTION

It is an objective of the present invention to provide a chargeable device, particularly a wireless chargeable device.

It is another objective of the present invention to provide a chargeable device which comprises a plurality of circuit modules operated with the same coil.

The present invention provides a chargeable device, comprising: an audio driving circuit for amplifying an audio signal; a wirewound speaker having a coil and a diaphragm, wherein the coil is connected to the audio driving circuit; and a battery charging circuit connected to the coil for charging a battery.

In one embodiment of the present invention, the chargeable device further comprises a compensation capacitor connected between the battery charging circuit and a ground.

In one embodiment of the present invention, the chargeable device further comprises a radio frequency (RF) circuit connected to the coil.

In one embodiment of the present invention, the RF circuit is selectively one of a radio frequency identification (RFID) circuit or a near field communication (NFC) circuit.

In one embodiment of the present invention, the chargeable device further comprises a compensation capacitor connected between the RF circuit and a ground.

In one embodiment of the present invention, the wirewound speaker is selectively one of a built-in speaker or an earphone.

In one embodiment of the present invention, the chargeable device further comprises a magnetic conducting layer coated on a surface of the diaphragm.

In one embodiment of the present invention, the chargeable device is selectively one of a mobile phone, a walkie-talkie, a multimedia player, a tablet PC, or a Bluetooth earphone.

In one embodiment of the present invention, the chargeable device further comprises a switch, wherein one end of the switch is connected to the coil, the other end of the switch is selectively switched to connect with one of the audio driving circuit or the battery charging circuit.

The present invention further provides a chargeable device, comprising: a coil; an RF circuit connected to the coil for receiving or transmitting RF signals; and a battery charging circuit connected to the coil for charging a battery.

In one embodiment of the present invention, the chargeable device further comprises a first compensation capacitor and a second compensation capacitor, wherein the first compensation capacitor is connected between the battery charging circuit and a ground, the second compensation capacitor is connected between the RF circuit and the ground.

In one embodiment of the present invention, the RF circuit is selectively one of an RFID circuit or an NFC circuit.

In one embodiment of the present invention, the chargeable device further comprises a switch connected between the coil and the battery charging circuit.

### BRIEF DESCRIPTION OF THE DRAWINGS

FIG. 1 is schematic equivalent circuit diagram of a chargeable device in accordance with one embodiment of the present invention.

FIG. 2 is a schematic structure diagram of a chargeable device in accordance with the embodiment shown in FIG. 1.

FIG. 3 is a schematic diagram of a chargeable device in accordance with another embodiment of the present invention.

FIG. 4 is a schematic diagram of a chargeable device in accordance with one embodiment of the present invention.

### DETAILED DESCRIPTION OF THE PREFERRED EMBODIMENTS

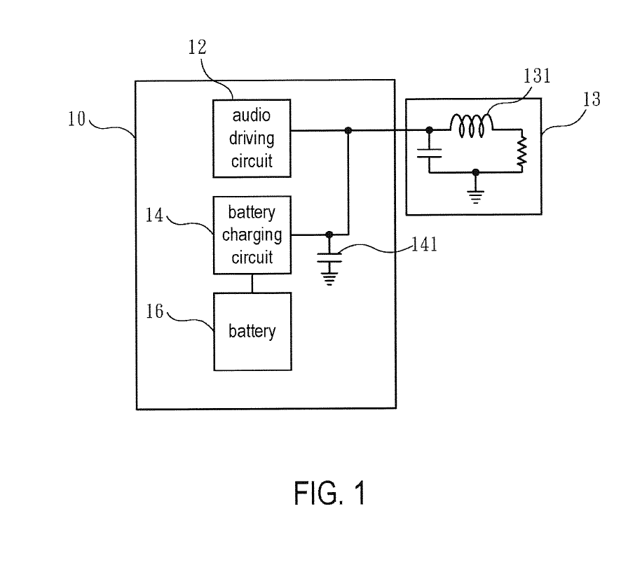

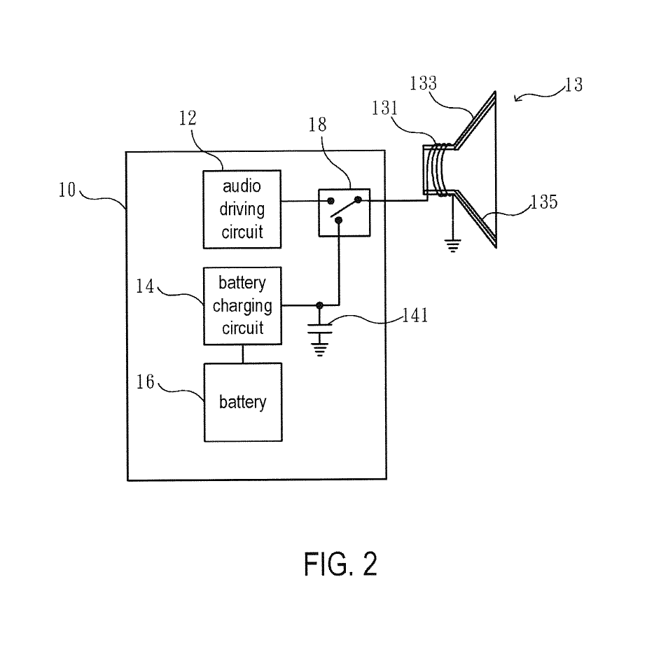

Referring to FIG. 1 and FIG. 2, a schematic equivalent circuit diagram and a schematic structure diagram of a chargeable device in accordance with one embodiment of the present invention is illustrated. In the present embodiment, the chargeable device 10 comprises an audio driving circuit 12, a wirewound speaker 13, and a battery charging circuit 14. The wirewound speaker 13 comprises a coil 131 and a diaphragm 133.

The audio driving circuit 12 receives audio signal, amplifies the audio signal and outputs the amplified audio signal to the wirewound speaker 13. When the audio signal passes through the coil 131 of the wirewound speaker 13, the diaphragm 133 is driven to vibrate and generate voice according to the audio signal.

The coil 131 of the wirewound speaker 13 can be used as an induction coil. When the coil 131 is exposed to a varying magnetic filed, an electromotive force is induced in the coil 131. The current driven by the electromotive force is rectified and regulated by the battery charging circuit 14 for charging the battery 16. In one embodiment of the present invention, the audio driving circuit 12 and the battery charging circuit 14 is controlled by the operation system (not shown) to be enabled or disabled. When the audio driving circuit 12 is operated, the battery charging circuit 14 is disabled. When the battery charging circuit 14 is operated, the audio driving circuit 12 is disabled.

In one embodiment of the present invention, the chargeable device 10 further comprises a compensation capacitor 141. One end of the compensation capacitor 141 is connected to the battery charging circuit 14, the other end of the compensation capacitor 141 is grounded. The compensation capacitor 141 is used for adjusting or matching the circuit to a proper operation frequency, and enhancing the efficiency of the battery charging circuit 14.

In one embodiment of the present invention, the wirewound speaker 13 is selectively one of a built-in speaker or an earphone.

In one embodiment of the present invention. the wirewound speaker 13 further comprises a magnetic conducting layer 135 coated on the surface of the diaphragm 133. By using the magnetic conducting layer 135, the magnetic field of a greater region is conducted to pass through the coil 131 to enhance the efficiency of battery charging.

In one embodiment of the present invention, the chargeable device 10 further comprises a switch 18 for switching the coil 131 to connect with the audio driving circuit 12 or the battery charging circuit 14.

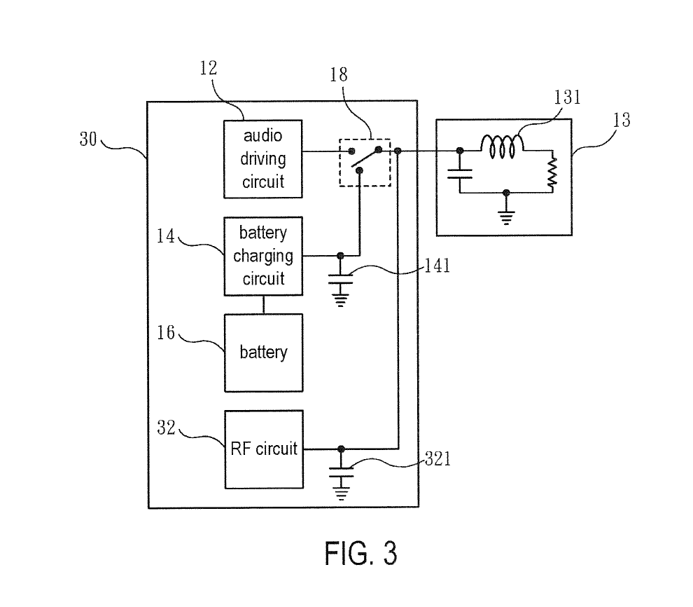

Referring to FIG. 3, a schematic diagram of a chargeable device in accordance with another embodiment of the present invention is illustrated. In the present embodiment, the structure of the chargeable device 30 is substantially the same as the embodiments shown in FIG. 1 and FIG. 2, wherein the chargeable device 30 of the present embodiment further comprises a radio frequency (RF) circuit 32 connected to the coil 131 of the wirewound speaker 13. The coil 131 can be used to receive or transmit RF signals for the RF circuit 32.

In one embodiment of the present invention, the RF circuit 32 is selectively one of a radio frequency identification (RFID) circuit or a near field communication (NFC) circuit.

In one embodiment of the present invention, the chargeable device 30 further comprises a compensation capacitor 321. One end of the compensation capacitor 321 is connected to the RF circuit 32 the other end of the compensation capacitor 321 is grounded. The compensation capacitor 321 is used for impedance matching and adjusting the operation frequency of the circuit.

In at least one of the aforementioned embodiments of the present invention, the chargeable device 10, 30 is selectively one of a mobile phone, a walkie-talkie, a multimedia player, a tablet PC, or a Bluetooth earphone.

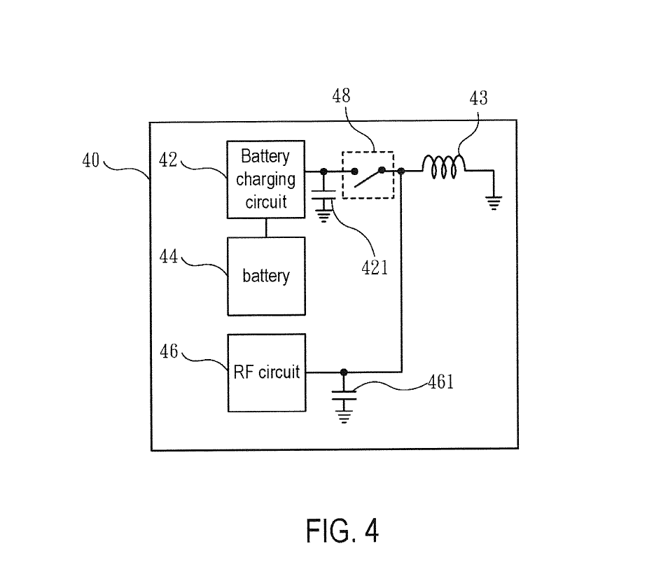

Referring to FIG. 4, a schematic diagram of a chargeable device in accordance with one embodiment of the present invention is illustrated. In the present embodiment, the chargeable device 40 comprises a coil 43, a battery charging circuit 42 and an RF circuit 46. The RF circuit 46 is connected to the coil 43 and is able to receive or transmit RF signals by using the coil 43.

The battery charging circuit 42 is also connected to the coil 43. When the coil 43 is exposed to a varying magnetic filed. an electromotive force is induced in the coil 43. The current driven by the electromotive force is rectified and regulated by the battery charging circuit 42 for charging the battery 44. In the present embodiment, the RF circuit 46 and the battery charging circuit 42 are controlled by the system to be enabled or disabled. When the RF circuit 46 is operated, the RF circuit 46 is enabled and the battery charging circuit 42 is disabled. On the other hand, when the battery charging circuit 42 is operated, the RF circuit 46 is disabled and the battery charging circuit 42 is enabled.

In one embodiment of the present invention, the chargeable device 40 further comprises a first compensation capacitor 421 and a second compensation capacitor 461. One end of the first compensation capacitor 421 is connected to the battery charging circuit 42 and the other end is grounded. The first compensation capacitor 421 is configured to adjust the operation frequency of the circuit and enhance the efficiency of battery charging. One end of the second compensation capacitor 461 is connected to the RF circuit 46 and the other end is grounded. The second compensation capacitor 461 is used for adjusting the operation frequency and impedance matching.

In one embodiment of the present invention, the chargeable device 40 further comprises a switch 48 connected between the coil 43 and the battery charging circuit 42. The battery charging circuit 42 can be selectively connected to or disconnected with the coil 43.

In one embodiment of the present invention, the dam-shaped structure 461 is selectively formed by one process of screen printing, imprinting, transfer printing, jet printing, etching, die casting, injection molding, or the combination thereof.

By using the structure of the present invention, the device that integrates battery charging circuit, audio driving circuit or RF circuit and comprises a requisite coil, such as the coil of a wirewound speaker, the induction coil of the battery charging circuit, or the coil antenna of the RF circuit, can use one coil to operate all functions of the device. Such that, the material and cost for the device production are reduced and the electromagnetic interference between the modules is prevented.

Although particular embodiments of the invention have been described in detail for purposes of illustration, various modifications and enhancements may be made without departing from the scope of the appended claims.

What is claimed is:

1. A chargeable device, comprising:
an audio driving circuit for amplifying an audio signal;
wirewound speaker having a coil and a diaphragm, wherein the coil is connected to the audio driving circuit; and
a battery charging circuit connected to the coil for charging a battery.

2. The chargeable device as claimed in claim 1, further comprising a compensation capacitor connected between the battery charging circuit and a ground.

3. The chargeable device as claimed in claim 1, further comprising a radio frequency (RF) circuit connected to the coil.

4. The chargeable device as claimed in claim 3, wherein the RF circuit is selectively one of a radio frequency identification (RFID) circuit or a near field communication (NFC) circuit.

5. The chargeable device as claimed in claim 3, further comprising a compensation capacitor connected between the RF circuit and a ground.

6. The chargeable device as claimed in claim 1, wherein the wirewound speaker is selectively one of a built-in speaker or an earphone.

7. The chargeable device as claimed in claim 1, further comprising a magnetic conducting layer coated on a surface of the diaphragm.

8. The chargeable device as claimed in claim 1, wherein the chargeable device is selectively one of a mobile phone, a walkie-talkie, a multimedia player, a tablet PC, or a Bluetooth earphone.

9. The chargeable device as claimed in claim 1, further comprising a switch, wherein one end of the switch is connected to the coil, the other end of the switch is selectively switched to connect with one of the audio driving circuit or the battery charging circuit.

10. A chargeable device, comprising:
a coil;
an RF circuit connected to the coil for receiving or transmitting RF signals; and
a battery charging circuit connected to the coil for charging a battery.

11. The chargeable device as claimed in claim 10, further comprising a first compensation capacitor and a second compensation capacitor, wherein the first compensation capacitor is connected between the battery charging circuit and a ground, the second compensation capacitor is connected between the RF circuit and the ground.

12. The chargeable device as claimed in claim 10, wherein the RF circuit is selectively one of an RFID circuit or an NFC circuit.

13. The chargeable device as claimed in claim 10, further comprising a switch connected between the coil and the battery charging circuit.
